(19) United States
(12) Patent Application Publication
(10) Pub. No.: US 2012/0079804 A1
(43) Pub. Date: Apr. 5, 2012

(54) COWL ASSEMBLY

(76) Inventors: Alan Roy Stuart, Cincinnati, OH (US); Kenneth Stephan Scheffel, Edgewood, KY (US)

(21) Appl. No.: 13/247,466

(22) Filed: Sep. 28, 2011

Related U.S. Application Data
(60) Provisional application No. 61/388,346, filed on Sep. 30, 2010.

(51) Int. Cl. F02K 3/02

(52) U.S. Cl. 60/226.2

(57) ABSTRACT

An assembly for a turbofan engine includes a first cowl member comprising an aft portion and a translatable cowl member comprising a forward portion configured to be received within the aft portion. The translatable cowl member is configured to be moveable with respect to the first cowl member between a first operational position wherein the forward portion is received within the aft portion of the first cowl member, and a second operational position wherein a smaller portion of the forward portion is received within the aft portion than in the first operational position. The translatable cowl member is configured to cooperate with a core cowl of the turbofan engine to define a portion of a fan duct having an exit nozzle, and the translatable cowl member is configured to define a flow control location near the exit nozzle that is associated with a controlling fan duct area.

### CROSS REFERENCE TO RELATED APPLICATIONS

This application claims priority to U.S. Provisional Patent Application No. 61/388,346, filed Sep. 30, 2010, the disclosure of which is incorporated by reference herein in its entirety.

### BACKGROUND

The present disclosure relates generally to turbofan engines, and more particularly to a cowl assembly for providing a variable fan nozzle in a turbofan engine.

Typically turbofan engines include a fan assembly, a core gas turbine engine enclosed in an annular core cowl, and a fan nacelle that surrounds a portion of the core gas turbine engine. The fan nacelle is spaced radially outward from the annular core cowl such that the core cowl and fan nacelle form a fan nozzle duct having a discharge area.

Typically, some turbofan engines include a thrust reverser assembly. The thrust reverser assemblies include a first fixed cowl and a second cowl that is axially translatable with respect to the first cowl. As the second cowl is repositioned, airflow is discharged from the fan nozzle duct through the thrust reverser assembly.

Fixed area fan nozzles determine fan operating parameters. The nozzle area of the fan nozzle duct is typically selected to protect fan stall margin and optimize fan efficiency, primarily at cruise. As used herein, the term “cruise” is used herein to primarily mean the level portion of aircraft travel, (e.g., where flight is most fuel efficient). Cruise typically occurs between aircraft ascent and aircraft descent phases of the flight envelope, which is usually the majority of an aircraft flight.

As disclosed herein, it may be desirable to vary the fan nozzle area to allow a higher thrust at top of climb while permitting the fan to operate more efficiently and quieter at take-off, cruise and decent idle power. Thus, as disclosed herein, the technical effects of the present disclosure provide one or more of the ability to vary the fan nozzle area to provide improvements in mission fuel burn, engine thrust, and aircraft noise.

### BRIEF DESCRIPTION OF EXEMPLARY EMBODIMENTS

Exemplary embodiments disclosed herein provide a cowl assembly for a turbofan engine assembly that includes a core gas turbine engine, and a core cowl that circumscribes the core gas turbine engine.

In one aspect, an assembly for a turbofan engine includes a first cowl member comprising an aft portion and a translatable cowl member comprising a forward portion configured to be received within the aft portion of the first cowl member. The translatable cowl member is configured to be moveable with respect to the first cowl member between a first operational position wherein the forward portion is received within the aft portion of the first cowl member, and a second operational position wherein a smaller portion of the forward portion is received within the aft portion than in the first operational position The translatable cowl member is configured to cooperate with a core cowl of the turbofan engine to define at least a portion of a fan duct having an exit nozzle, and the translatable cowl member is configured to define a flow control location near the exit nozzle. The flow control location is associated with a controlling fan duct area.

In another aspect, a method of controlling a fan duct area of a turbofan engine assembly includes providing a translatable cowl member in cooperation with a core cowl of a the turbofan engine to define at least a portion of a fan duct having an exit nozzle and to define a flow control location near the exit nozzle. The flow control location is associated with a controlling fan duct area The method includes moving the translatable cowl member with respect to a first cowl member between a first operational position and a second operational position in order to vary a magnitude of the controlling fan duct area at the flow control location.

### BRIEF DESCRIPTION OF THE DRAWINGS

FIG. 1 is a schematic view of an exemplary aircraft turbofan engine assembly that includes an exemplary cowl assembly.

FIG. 2 is a partial sectional side view showing an exemplary cowl assembly in a first operational position.

FIG. 3 is a partial sectional side view showing an exemplary cowl assembly in a second operational position;

FIG. 4 is a partial sectional side view showing an exemplary cowl assembly in a third operational position.

FIG. 5 is a partial section side view showing another exemplary cowl assembly in a third operation position.

### DETAILED DESCRIPTION OF EXEMPLARY EMBODIMENTS

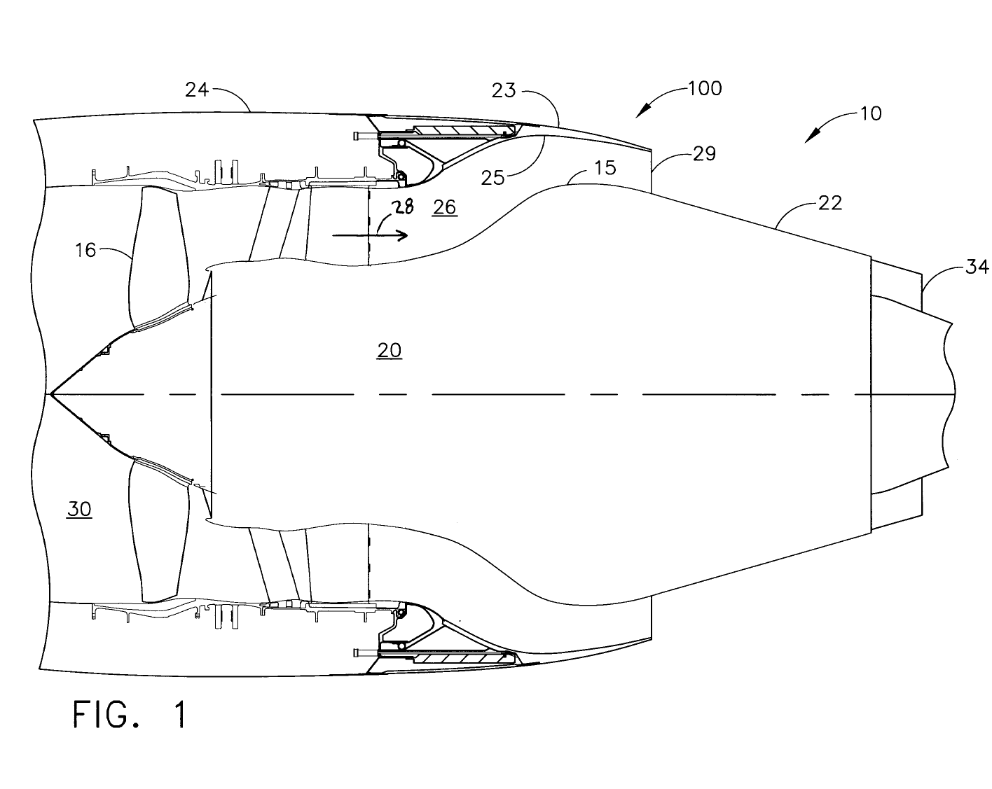

FIG. 1 shows an exemplary turbofan engine assembly 10. In an exemplary embodiment, turbofan engine assembly 10 includes a core gas turbine engine 20. In an exemplary embodiment, turbofan engine assembly 10 includes an annular core cowl 22 that extends around core gas turbine engine 20 and includes a radially outer surface 15. In further embodiments, turbofan engine assembly 10 also includes an inlet 30, a first outlet 29, and a second outlet 34.

In one embodiment, fan nacelle 24 surrounds fan assembly 16 and is spaced radially outward from core cowl 22. Nacelle 24 includes a radially outer surface 23 and a radially inner surface 25. A fan duct 26 is generally defined between radially outer surface 15 of core cowl 22 and radially inner surface 25 of nacelle 24.

During operation, airflow enters inlet 30, flows through fan assembly 16, and is discharged downstream. A first portion of the airflow is channeled through core gas turbine engine 20, compressed, mixed with fuel, and ignited for generating combustion gases that are discharged from core gas turbine engine 20 through second outlet 34. In forward thrust operations, a second portion of the airflow 28 is channeled downstream through fan duct 26 and is discharged from fan duct 26 through first outlet 29, also referred to as a fan exit nozzle. In an exemplary embodiment, nacelle 24 includes a cowl assembly 100 as described in greater detail below.

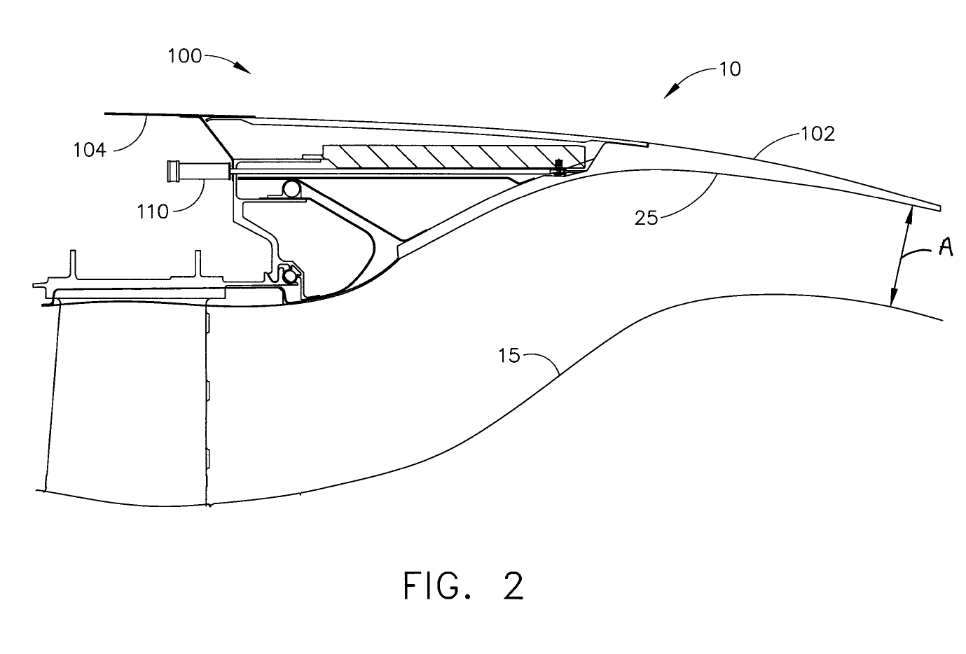

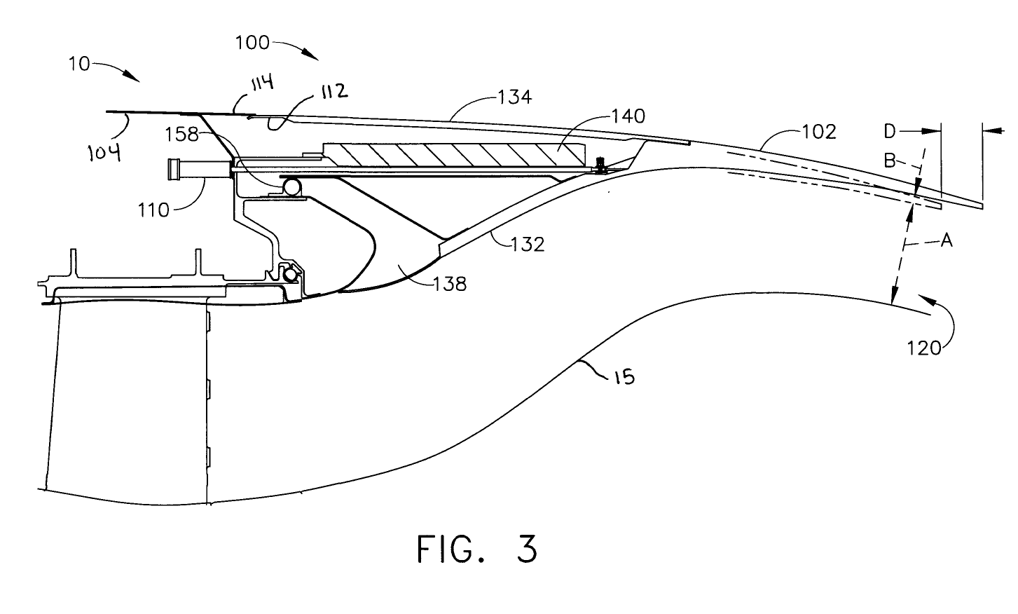

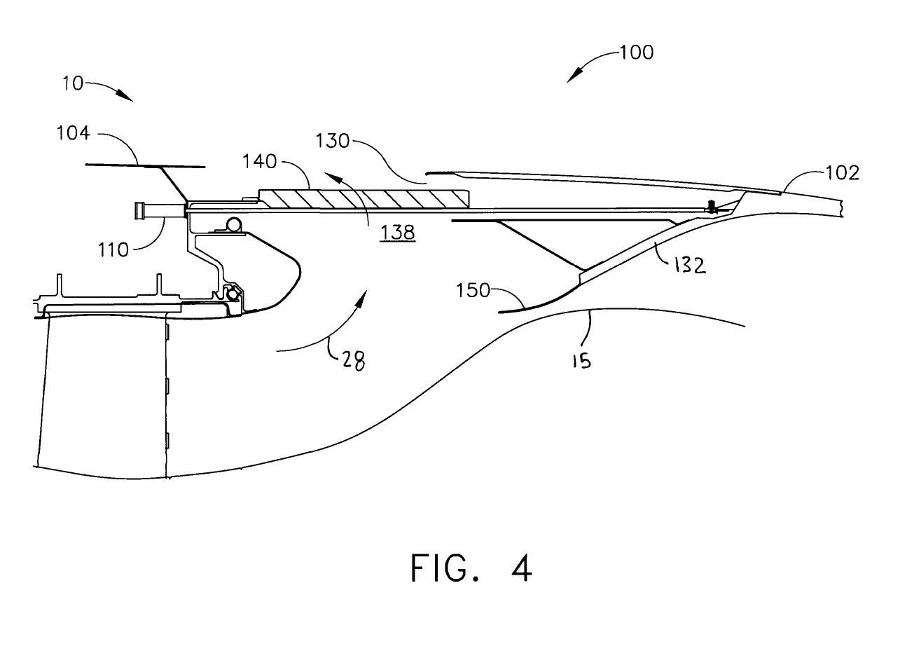

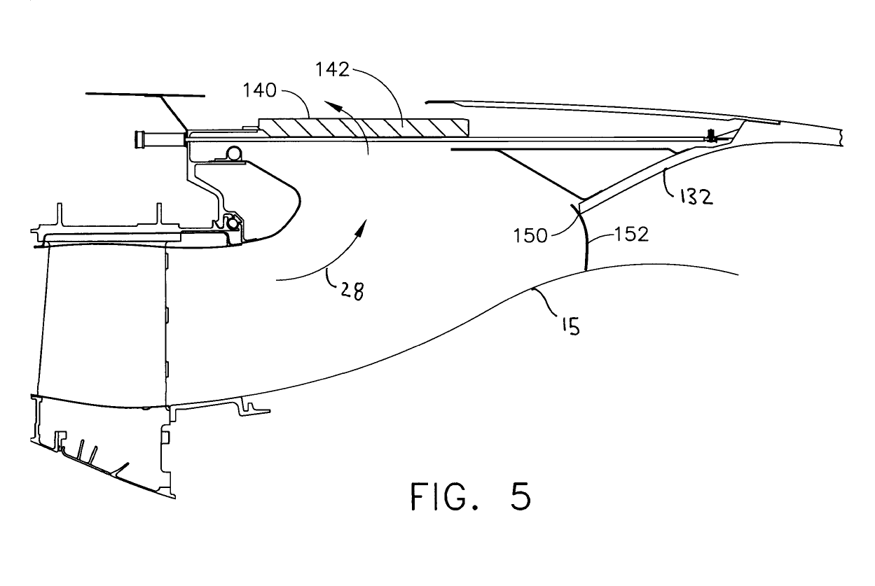

With reference to FIGS. 2-5, in an exemplary embodiment, cowl assembly 100 includes a translatable cowl member 102 that defines a portion of nacelle 24. In the exemplary embodiment, translatable cowl member 102 is movably coupled to a stationary first cowl member 104. FIG. 2 shows a partial sectional side view of an exemplary embodiment showing the translatable cowl member 102 in a first operational position (i.e., stowed). FIG. 3 is a partial sectional side view of an exemplary embodiment showing the translatable cowl member 102 in a second operational position (i.e., partially translated). FIG. 4 is a partial sectional side view of an exemplary embodiment showing the translatable cowl member 102 in a third operational position (i.e., fully deployed). FIG. 5 illustrates another exemplary embodiment wherein the translatable cowl member 102 is in a third operational position (i.e., fully deployed).

In an exemplary embodiment, an actuator assembly 110 is coupled to translatable cowl member 102 to selectively translate cowl member 102 in a generally axial direction relative to first cowl member 104. In the exemplary embodiment, actuator assembly 110 is positioned within a portion of the area defined by nacelle 24. In the exemplary embodiment, actuator assembly 110 may be electrically, pneumatically, or hydraulically powered in order to translate cowl member 102 between the operational positions.

An exemplary embodiment includes a first cowl member 104 including an aft portion 114 and a translatable cowl member 102 including a forward portion 112 being sized and configured to be telescopingly received within the aft portion 114 of the first cowl member 104. The translatable cowl member 102 is operably moveable with respect to the first cowl member 104 at least between a first operational position (see FIG. 2) wherein substantially all of the forward portion 112 is received within the aft portion 114, and a second operational position (see FIG. 3) wherein some, but less than the amount in the first operational position, of the forward portion 112 is received within the aft portion 114. In an exemplary embodiment, translatable cowl member 102 and first cowl member 104 are sized and/or configured to minimize a step on the outer surface of nacelle 24 at the overlapping portions.

The translatable cowl member 102 is sized and/or configured to cooperate with the core cowl 22 to define at least a portion of a fan duct 26 having an fan exit nozzle 29. Further, the translatable cowl member 102 is sized and/or configured to define a flow control location 120 near the fan exit nozzle 29, wherein the flow control location 120 is associated with a controlling fan duct area. For example, when the translatable cowl member 102 is in the first operational position, the controlling fan duct area is represented by arrow A in FIG. 2. When the translatable cowl member 102 is in the second operational position, as illustrated in FIG. 3, the controlling fan duct area increases as depicted by the gap between arrow A and arrow B. Thus, movement of the translatable cowl member 102 with respect to the first cowl member 104 between the first operational position and the second operational position is operative to vary a magnitude of the controlling fan duct area at the flow control location 120. As illustrated in FIG. 3, the flow control location 120 remains substantially at or near the fan nozzle exit even with a change in flow control area, and with the associated increase in the length of the fan duct as illustrated by distance D. Thus, the translatable cowl member 102 cooperates with core cowl 22 to provide a variable fan nozzle to provide improved fan efficiency. As shown in FIG. 3, a seal member 158 may be utilized to minimize air leakage when the translatable cowl is in the second operational position.

In an exemplary embodiment, the airflow in the fan duct 26 is at a low mach number (i.e., less than sonic) and it is generally converging to a controlling flow area at or near the fan exit nozzle 29. Although the accompanying Figures only partially show the translatable cowl member, in an exemplary embodiment, the entire translatable cowl moves in order to vary the controlling fan duct area.

An exemplary translatable cowl member 102 includes a radially inner panel 132 and a radially outer panel 134 being arranged and configured to define a space 138 therebetween. In one embodiment, translatable cowl member 102 provides a thrust reversing operation. In an exemplary embodiment, a thrust reverser member 140 is positioned relative to the space 138 between the radially inner and outer panels 132, 134, respectively so as to be selectively covered and uncovered by the translatable cowl member 102. Thus, when the translatable cowl member 102 is disposed in the first or second operational positions, the thrust reverser member 140 is covered, and movement of translatable cowl member 102 may be utilized to vary the fan nozzle duct as described above. When the translatable cowl member 102 is in the third operational position, the thrust reverser member is uncovered. Those having skill in the art will appreciate that appropriate flow directing members and seals are utilized in the exemplary embodiments.

In an exemplary embodiment, thrust reverser member 140 may be a fixed cascade structure including a plurality of cascade turning vanes 142.

In an exemplary embodiment, in operation, when the translatable cowl member 102 is in either of the first or second operational positions, air in the fan duct 26 is generally directed out of fan exit nozzle 29 in a forward thrust operation. In another embodiment, the translatable cowl member 102 is moved into the third operational position whereby the thrust reverser member 140 is uncovered and airflow is directed through the turning vanes 142, also referred to as vents, to provide reverse thrust.

In an exemplary embodiment, when the translatable cowl member 102 is in the third operational position, for example as illustrated in FIGS. 4 and 5, fan duct 26 is substantially blocked to reduce or inhibit airflow through the fan exit nozzle 29. Instead, the airflow is directed through the thrust reverser member 140 in a reverse thrust operation. It is envisioned that a conventional blocker door design may be utilized. In other exemplary embodiments, a hybrid design may be utilized as described in applicant's co-pending non-provisional application Ser. No. ______, referenced by docket number 226122-2, which claims priority to provisional application No. 61/388,360, filed Sep. 30, 2010, the disclosures of which are hereby incorporated by reference in their entireties.

FIG. 4 illustrates an exemplary “blocker-door-less” type thrust reverser wherein a portion 150 of the radially inner panel 132 cooperates with the radially outer surface 15 of the core cowl 22 to substantially block airflow through the fan duct 26 and out fan exit nozzle 29. FIG. 5 illustrates an exemplary “blocker door type” thrust reverser where the portion 150 of the radially inner panel 132 includes a door or moveable member 152 operable to move into the fan duct 26 and cooperate with surface 15 of core cowl 22 to substantially block or inhibit the airflow from exiting through fan exit nozzle 29.

Embodiments disclosed herein include an exemplary cowl assembly 100 for use with a turbofan engine. The exemplary assembly 100 includes a first cowl member 104, including an aft portion 114, and a translatable cowl member 102, including a forward portion 112 being sized and/or configured to be telescopingly received within the aft portion 114 of the first cowl member 104. In one embodiment, the translatable cowl member 102 is operably moveable with respect to the first cowl member 104 at least between a first operational position wherein substantially all of the forward portion 112 is received within the aft portion 114, and a second operational position wherein some, but less than all, of the forward portion 112 is received within the aft portion 114. In another embodiment, an exemplary translatable cowl member 102 is sized and/or configured to cooperate with a core cowl 22 of a turbofan engine 20 to define at least a portion of a fan duct 26 having an fan exit nozzle 29. In yet another embodiment, an exemplary translatable cowl member 102 is sized and/or configured to define a flow control location 120 near the fan exit nozzle 29, which is associated with a controlling fan duct area. Movement of the translatable cowl member 102 with respect to the first cowl member 104 between the first operational position and the second operational position is operative to vary a magnitude of the controlling fan duct area at the flow control location 120.

In an exemplary embodiment, the translatable cowl member 102 is further operably movable with respect to the first cowl member 104 into a third operational position wherein the forward portion 112 is disposed away from the aft portion 114 to provide an opening 130 therebetween.

In an exemplary embodiment, the translatable cowl member 102 includes a radially inner panel 132 and a radially outer panel 134 being arranged and configured to define a space 138 therebetween. The exemplary cowl assembly 100 includes a thrust reverser member 140 positioned relative to the space 138 between the radially inner and outer panels 132, 134, respectively, so as to be selectively covered and uncovered by the translatable cowl member 102. When the translatable cowl member 102 is disposed in the first or second operational positions, the thrust reverser member 140 is covered, and when the translatable cowl member 102 is in the third operational position, the thrust reverser member 140 is uncovered.

In an exemplary embodiment, portion 150 of the radially inner panel 132 is arranged and configured such that when the translatable cowl member 102 is in the third operational position, the fan duct 26 is substantially blocked at a location forward of the fan exit nozzle 29.

In an exemplary embodiment, a portion 150 of the radially inner panel 132 includes at least one movable blocker door 152.

In an exemplary embodiment, the thrust reverser member 140 includes a plurality of flow directing vents 142.

An exemplary embodiment includes an actuator assembly 110 coupled to the translatable cowl member 102 such that the actuator assembly 110 is configured and arranged to move the translatable cowl member 102 between the first, second, and third operational positions.

In some embodiments, the systems and method disclosed herein may be facilitated by a computer or stored on a computer readable medium.

The embodiments described herein are not limited to any particular system controller or processor for performing the processing tasks described herein. The term controller or processor, as used herein, is intended to denote any machine capable of performing the calculations, or computations, necessary to perform the tasks described herein. The terms controller and processor also are intended to denote any machine that is capable of accepting a structured input and of processing the input in accordance with prescribed rules to produce an output. It should also be noted that the phrase “configured to” as used herein means that the controller/processor is equipped with a combination of hardware and software for performing the tasks of embodiments of the invention, as will be understood by those skilled in the art. The term controller/processor, as used herein, refers to central processing units, microprocessors, microcontrollers, reduced instruction set circuits (RISC), application specific integrated circuits (ASIC), logic circuits, and any other circuit or processor capable of executing the functions described herein.

The embodiments described herein may embrace one or more computer readable media, including non-transitory computer readable storage media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Aspects of the disclosure transform a general-purpose computer into a special-purpose computing device when configured to execute the instructions described herein. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An assembly for a turbofan engine, comprising:
a first cowl member comprising an aft portion;
a translatable cowl member comprising a forward portion configured to be received within the aft portion of the first cowl member,
wherein the translatable cowl member is configured to be moveable with respect to the first cowl member between a first operational position wherein the forward portion is received within the aft portion of the first cowl member, and a second operational position wherein a smaller portion of the forward portion is received within the aft portion than in the first operational position; and
wherein the translatable cowl member is configured to cooperate with a core cowl of the turbofan engine to define at least a portion of a fan duct having an exit nozzle, and the translatable cowl member is configured to define a flow control location near the exit nozzle, wherein the flow control location is associated with a controlling fan duct area.

2. The assembly according to claim 1, wherein movement of the translatable cowl member with respect to the first cowl member, between the first operational position and the second operational position, is operative to vary a magnitude of the controlling fan duct area at the flow control location.

3. The assembly according to claim 1, wherein the forward portion of the translatable cowl member is configured to be telescopically received within the aft portion of the first cowl member.

4. The assembly according to claim 1, wherein the translatable cowl member is further configured to be movable with respect to the first cowl member into a third operational position wherein the forward portion is disposed away from the aft portion to provide an opening between the forward portion and the aft portion.

5. The assembly according to claim 4,
wherein the translatable cowl member comprises a radially inner panel and a radially outer panel defining a space therebetween, and
a thrust reverser member is positioned relative to the space between the radially inner and outer panels so as to be selectively covered and uncovered by the translatable cowl member, wherein when the translatable cowl member is disposed in the first or second operational positions, the thrust reverser member is covered, and when the translatable cowl member is in the third operational position, the thrust reverser member is uncovered.

6. The assembly according to claim 5, wherein a portion of the radially inner panel is configured such that when the translatable cowl member is in the third operational position, the fan duct is substantially blocked at a location forward of the fan nozzle.

7. The assembly according to claim 5, wherein the portion of the radially inner panel comprises at least one movable blocker door.

8. The assembly according to claim 5, wherein the thrust reverser member comprises a plurality of flow directing vents.

9. The assembly according to claim 4, further comprising:
an actuator assembly coupled to the translatable cowl member and the actuator assembly is configured to move the translatable cowl member between the first, second, and third operational positions.

10. The assembly according to claim 9, wherein the translatable cowl member comprises a radially inner panel and a radially outer panel arranged to define a space therebetween, and the assembly further comprising:
a thrust reverser member positioned relative to the space between the radially inner and outer panels so as to be selectively covered and uncovered by the translatable cowl member, wherein when the translatable cowl member is disposed in the first or second operational positions, the thrust reverser member is covered, and when the translatable cowl member is in the third operational position, the thrust reverser member is uncovered.

11. The assembly according to claim 10, wherein a portion of the radially inner panel is configured such that when the translatable cowl member is in the third operational position, the fan duct is substantially blocked at a location forward of the fan nozzle.

12. The assembly according to claim 11, wherein the portion of the radially inner panel comprises at least one movable blocker door.

13. The assembly according to claim 10, wherein the thrust reverser member comprises a plurality of flow directing vents.

14. The assembly according to claim 1, further comprising a sealing member disposed between the translatable cowl member and the first cowl member.

15. A method of controlling a fan duct area of a turbofan engine assembly, the method comprising:
providing a translatable cowl member in cooperation with a core cowl of the turbofan engine to define at least a portion of a fan duct having an exit nozzle and to define a flow control location near the exit nozzle, wherein the flow control location is associated with a controlling fan duct area;
moving the translatable cowl member with respect to a first cowl member between a first operational position and a second operational position to vary a magnitude of the controlling fan duct area at the flow control location.

16. The method according to claim 15, further comprising telescopically receiving the forward portion of the translatable cowl member within the aft portion of the first cowl member.

17. The method according to claim 15, further comprising moving the translatable cowl member with respect to the first cowl member into a third operational position wherein the forward portion is disposed away from the aft portion to provide an opening between the forward portion and the aft portion.

18. The method according to claim 17, wherein the translatable cowl member comprises a radially inner panel and a radially outer panel defining a space therebetween, and the method further comprises:
positioning a thrust reverser member relative to the space between the radially inner and outer panels so as to be selectively covered and uncovered by the translatable cowl member, wherein when the translatable cowl member is disposed in the first or second operational positions, the thrust reverser member is covered, and when the translatable cowl member is in the third operational position, the thrust reverser member is uncovered.

19. The method according to claim 18, wherein a portion of the radially inner panel is configured such that when the translatable cowl member is in the third operational position, the fan duct is substantially blocked at a location forward of the fan nozzle.

20. The method according to claim 18, wherein the portion of the radially inner panel comprises at least one movable blocker door.

21. The assembly according to claim 18, wherein the thrust reverser member comprises a plurality of flow directing vents.

22. A non-transitory computer readable medium storing program instructions to control a computer to implement a method of controlling a fan duct area of a turbofan engine assembly, the turbofan engine assembly comprising a translatable cowl member in cooperation with a core cowl of the turbofan engine defining at least a portion of a fan duct having an exit nozzle and defining a flow control location near the exit nozzle, wherein the flow control location is associated with a controlling fan duct area, the method comprising:
moving the translatable cowl member with respect to a first cowl member between a first operational position and a second operational position to vary a magnitude of the controlling fan duct area at the flow control location.
